(19) United States
(12) Patent Application Publication
(10) Pub. No.: US 2015/0366257 A1
(43) Pub. Date: Dec. 24, 2015

(54) NUTRITIONALLY COMPLETE COMPOSITION FOR CALORIE-BALANCED DIET

(71) Applicant: Aleh Manchuliantsau, Vitebsk (BY)

(72) Inventor: Aleh Manchuliantsau, Vitebsk (BY)

(21) Appl. No.: 14/823,002

(22) Filed: Aug. 11, 2015

Related U.S. Application Data
(63) Continuation-in-part of application No. 14/745,674, filed on Jun. 22, 2015.
(60) Provisional application No. 62/015,386, filed on Jun. 20, 2014.

(51) Int. Cl. A23L 1/36; A23L 1/303; A23L 2/39; A23L 1/308; A23L 1/302; A23L 1/305; A23L 1/304

(52) U.S. Cl. CPC A23L 1/36; A23L 1/305; A23L 1/303; A23L 1/304; A23L 1/308; A23L 1/302; A23L 2/39; A23V 2002/00

(57) ABSTRACT

A nutritional composition is designed to be a complete meal, which includes nutrients, vitamins, and minerals, all of which are needed to sustain a healthy diet. The ingredients of nutritional composition are provided in amounts to meet recommended dosages so that a total fat value is at about 30% of total calorie value, a total carbohydrate value is about 40-60% of total calorie value, and a total protein value is about 10-30% of total calorie value of the nutritional composition. According to certain embodiments, the nutritional composition includes a mixture of flax seeds at about 3 grams to about 6 grams per 100 kcal, hemp seeds at about 1 gram to about 3 grams per 100 kcal, plant flour at about 2 grams to about 9 grams per 100 kcal, and optionally other ingredients such as protein, protein isolate, sesame seeds, flavoring agent, and processing liquid.

### CROSS-REFERENCE TO RELATED APPLICATIONS

This application is Continuation-in-Part of U.S. utility, non-provisional patent application Ser. No. 14/745,674 filed on Jun. 22, 2015, entitled “Method and Apparatus for Making Customized Nutritional Mixtures,” which is incorporated herein by reference in its entirety for all purposes.

This application also claims the benefit of U.S. provisional patent application Ser. No. 62/015,386 filed on Jun. 20, 2014, entitled “Method and Apparatus for Making Customized Nutritional Mixtures,” which is incorporated herein by reference in its entirety for all purposes.

### TECHNICAL FIELD

This disclosure generally relates to nutritional mixtures and methods for making nutritional mixtures. More particularly, this disclosure relates to a healthy, balanced, and nutritionally complete composition, which includes calories, nutrients, vitamins, and minerals, all in proportions selected to meet minimum recommended dosages for a healthy living.

### DESCRIPTION OF RELATED ART

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Nutritionists suggest that general health starts with a proper diet and eating habits. Today, many diets are available to help people reach their particular goals for weight loss, gain weight, stay healthy, and even treat certain medical conditions. Typically, diets include multiple meal ingredients or foodstuff at certain proportions or weights that an individual shall mix or prepare for further intake on a daily basis. One of the problems with existing diets is that it may be difficult or annoying for the users to make meals satisfying a plurality of requirements of a particular diet including certain weights, dosages, and proportions. Another problem with existing diets is that they typically focused on addressing a particular health problem and often include some ingredients in elevated amounts and some other ingredients in decreased amounts. For this reason, many diets are not suitable to use for long periods of time.

Another problem with the existing diets is that they are not necessarily provide all relevant nutrients for an individual to intake on a daily basis to remain healthy. For example, most nutritionists suggest taking multivitamins in addition to adhering to a particular diet because foodstuff may lack essential vitamins, fats, minerals, fatty and amino acids. For example, American diets tend to be too low in Omega-3, so most nutritionists suggest that Americans will benefit from additional daily intake of Omega-3. Thus, it may be very difficult to the general public to make sure their meals include all relevant nutrients at recommended dosages on a daily basis.

Yet another problem with known diets is the difficulty of calculating a calorie value of consumed meals by an individual. For example, if a particular individual wants to keep tracking of daily caloric intake (e.g., if the individual wants to adhere to a 2000-calorie diet), it can be not only annoying, but nearly possible to determine a number of calories obtained to consumed with a particular calorie intake value. Accordingly, the adherence to calorie-based diets is not easy and typically inaccurate.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The present disclosure generally relates to a nutritional composition and a method for its making, which overcome at least some drawbacks known in the art. The nutritional composition is designed to be a complete meal and include multiple nutrients, vitamins, and minerals, all of which are relevant to digest by an individual on a daily basis. According to embodiments of this disclosure, the nutritional composition includes about 100% dosages of all relevant or recommended nutrients, vitamins, and minerals, which in aggregate provide a predetermined optimal amount of calories per serving (or per day) to maintain a healthy diet. Thus, when an individual consumes the nutritional composition according to this disclosure, there is no need to take any other meals, because the nutritional composition already provides all needed nutrients in dosages required to remain healthy or achieve a particular goal such as loose or gain weight. Importantly, ingredients selected for making the nutritional composition may include only natural ingredients, which are healthy and wholesome. They also are sources of carbohydrates, fats, and proteins, which are also selected in proportions optimal or recommended for daily intake. The nutritional composition ingredients also include dietary fiber, fatty acids, and amino acids in relevant amounts. Thus, the nutritional composition, according to the embodiments of this disclosure, includes a complete meal, which provides a calorie intake optimal to a predetermined diet, as well as it includes nutrients, vitamins, and minerals optimal to remain healthy, with no need to eat anything else.

According to one non-limiting aspect of this disclosure, there is provided a nutritional composition, which includes a mix or blend of flax seeds, hemp seeds, and plant flour. In some embodiments, flax seeds derivative and hemp seeds derivative products can be used. The flax seeds and hemp seeds are mixed in the following proportions: the flax seeds are at about 3 grams to about 6 grams per 100 kcal of the nutritional composition and the hemp seeds at about 1 gram to about 3 grams per 100 kcal of the nutritional composition. The plant flour can include a flour or starch derived from a gluten-free plant. For example, the plant flour can include rice flour, oat flour, and/or soy flour. The plant flour can be at about 2 grams to about 9 grams per 100 kcal of the nutritional composition.

In certain embodiments, the nutritional composition further includes sugars. The sugars may include dextrose, glucose, fructose, sucrose, and/or inverted sugar. The sugars present at about 1 gram to about 7 grams per 100 kcal of the nutritional composition.

In certain embodiments, the nutritional composition further includes sesame seeds or a derivative thereof such as white hulled sesame seeds. The sesame seeds are present in the nutritional composition at a range from about 0.3 grams to about 1 gram per 100 kcal of the nutritional composition.

In certain embodiments, the nutritional composition further includes a protein ingredient, which can includes rice protein, soy protein, whey protein, hemp protein, pea protein, casein, or any combination thereof. The protein can be present in the nutritional composition at a range from about 2 grams to about 5 grams per 100 kcal of the nutritional composition. In certain embodiments, the nutritional composition may comprise a protein isolate.

In certain embodiments, the nutritional composition further includes lecithin such as at the range from about 1 gram to about 3 grams per 100 kcal of the nutritional composition. In yet other embodiments, the nutritional composition may further include a flavoring agent such as chocolate or vanilla.

In certain embodiments, the nutritional composition includes the following vitamins: vitamin A in amount from about 1,000 International Units (IU) to about 5,000 IU, vitamin B1 in amount from about 0.5 milligrams (mg) to about 2 mg, vitamin B2 in amount from about 0.5 mg to about 2 mg, vitamin B3 in amount from about 6 mg to about 35 mg, vitamin B5 in amount from about 0.5 mg to about 10 mg, vitamin B6 in amount from about 0.5 mg to about 100 mg, vitamin B12 in amount from about 2 μg to about 6 μg, biotin in amount from about 100 μg to about 300 μg, vitamin C in amount from about 20 mg to about 2,000 mg, vitamin D in amount from about 130 IU to about 400 IU, vitamin E in amount from about 10 IU to about 3,000 IU, folic acid in amount from about 130 μg to about 1,000 μg, vitamin K in amount from about 26 μg to about 80 μg.

In certain embodiments, the nutritional composition includes the following minerals: calcium in amount from about 330 mg to about 2,500 mg, chloride in amount from about 1,100 mg to about 3,400 mg, chromium in amount from about 40 μg to about 120 μg, copper in amount from about 0.7 mg to about 10 mg, fluoride in amount from about 0 mg to about 10 mg, iodine in amount from about 50 μg to about 1,100 μg, iron in amount from about 6 mg to about 1,100 mg, magnesium in amount from about 130 mg to about 400 mg, manganese in amount from about 0.7 mg to about 11 mg, molybdenum in amount from about 25 μg to about 2,000 μg, phosphorus in amount from about 330 mg to about 4,000 mg, potassium in amount from about 1,150 mg to about 3,500 mg, selenium in amount from about 23 μg to about 400 μg, sodium in amount from about 800 mg to about 2,300 mg, and zinc in amount from about 5 mg to about 40 mg.

In certain embodiments, the nutritional composition further comprises omega-3 fatty acids in an amount from about 0.5 to about 1.6 grams and omega-6 fatty acids in an amount from about 5 to about 17 grams. In certain embodiments, the nutritional composition further comprises dietary fiber in an amount from about 5 to 30 grams. In certain embodiments, the nutritional composition further includes one or more of the following additional ingredients: guarana, glucuronolactone, taurine, ginseng, coffee, caffeine, tea, kola nut, cocoa, yerba mate, and Ginkgo biloba.

In certain embodiments, a total fat value of the nutritional composition is about 30% of total calorie value of the nutritional composition, a total carbohydrate value of the nutritional composition is in the range from about 40% to about 60% of total calorie value of the nutritional composition, and a total protein value of the nutritional composition is in the range from about 10% to about 30% of total calorie value of the nutritional composition.

In certain embodiments, the nutritional composition can be dissolved in a consumable liquid. The consumable liquid may include water, milk, diary product, non-diary drink, almond milk, soy milk, coconut water, juice, soda water, soft drink, lemonade, and energy drink.

In certain embodiments, the nutritional composition is provided in multiple servings, where an energy value of each serving is not greater than 1,000 kcal.

According to another aspect of this disclosure, there is provided a packaged food product comprising a nutritional composition. The nutritional composition includes: (i) flax seeds or a flax seed derivative; (ii) hemp seeds or a hemp seed derivative; and (iii) plant flour derived from rice, oat, or soy. The nutritional composition includes a total fat value at about 30% of total calorie value of the nutritional composition, a total carbohydrate value at a range from about 40% to about 60% of total calorie value of the nutritional composition, and a total protein value at a range from about 10% to about 30% of total calorie value of the nutritional composition.

According to yet another aspect of this disclosure, there is provided a method for making a nutritional composition. The method comprises the steps of (i) dispensing flax seeds at about 3 grams to about 6 grams per 100 kcal of the nutritional composition; (ii) dispensing hemp seeds at about 1 gram to about 3 grams per 100 kcal of the nutritional composition; (iii) dispensing plant flour (e.g., rice flour, oat flour, and/or soy flour) at about 2 grams to about 9 grams per 100 kcal of the nutritional composition; and (iv) combining the flax seeds, hemp seeds, and the plant flour in a container.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 shows a process flow diagram of a method for making a nutritional composition.

FIG. 2 shows an example container containing a nutritional composition.

### DETAILED DESCRIPTION OF EXAMPLE EMBODIMENTS

The following detailed description of embodiments includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

This disclosure relates to a nutritional composition and a method for making thereof. The nutritional composition includes a mix of flax seeds, hemp seeds, and plant flour (e.g., rice flour). In certain embodiments, the nutritional composition may further include one or more additional ingredients such as sesame seeds, sugars, protein, protein isolate, lecithin, flavoring agents, color agents, vitamins, minerals, fatty acids, amino acids, guarana, glucuronolactone, taurine, ginseng, coffee, caffeine, tea, kola nut, cocoa, yerba mate, and Ginkgo biloba. The nutritional composition is designed to be a nutritionally complete meal and correspond to a predetermined or recommended calorie intake value, which can be individually calculated for each customer based on individual characteristics, individual goals, and other factors. The nutritional composition also provides all nutrients, vitamins, and minerals relevant to an individual for consumption on a daily basis based on recommended dosages depending on individual characteristics, goals, and other factors. There is no need for an individual to intake any other meals or foodstuff because the nutritional composition according to this disclosure provides about 100% of all needed nutrients, minerals, and vitamins.

The term “composition” shall mean a combination of two or more ingredients according to various embodiments of this disclosure. As indicated above, the ingredients may refer to disparate nutrients, vitamins, minerals, fibers, fatty acids, amino acids, fats, carbohydrates, proteins, and any other consumable products. In certain embodiments, the terms “composition” and “nutritional composition” can refer to a dry mixture, blend or powder, but in other embodiments, these terms can refer to a liquid, beverage, drink, smoothie, jelly, soup, paste, spread, or dough. In yet other embodiments, the terms “composition” and “nutritional composition” can refer to processed products (e.g., nutritional bars, snack bars), bakery products, cooked products, compressed products, and so forth. The terms “composition” and “nutritional composition” can also refer to a nutritional supplement, food supplement, dietary supplement, and the like.

In some embodiments, the nutritional composition can be dispensed, mixed, or packaged. The term “packaged” shall mean that the nutritional composition is contained in a container. The term “container” shall mean any compressible or non-compressible container or receptacle usually used for mixing and/or storing solids, liquids, or semi-liquids. Some examples of the container include, but not limited to, a bottle, flask, package, packet, wrap, foil, polymer film, pot, beaker, vat, cask, barrel, pitcher, bowl, and cup.

The term “about” shall mean a reasonable deviation of a value accompanying this term. If it is not specified otherwise, the term “about” may refer to a variation of 10% from an indicated value. In the case of a range of values, the term “about” may refer to a 10% variation from both the lower and upper limits of the range.

The term “individual,” as used herein, shall mean any person or animal that can consume a nutritional composition made according to embodiments of this disclosure. The term “individual” also mean a user, consumer, customer, patient, operator, and the like, and can be used interchangeably.

Referring now to the drawings and specific examples for the purpose of illustrating embodiments, and not for the purpose of limiting the same, the present nutritional composition includes a combination of ingredients, which are sources of carbohydrates, fats, proteins, vitamins, and minerals scientifically designed to provide nutritionally complete food for maintaining a healthy diet. The term “nutritionally complete” means that the nutritional composition according to this disclosure provides at least or about 100% of nutrients, vitamins, and minerals required or recommended for an individual to remain healthy or to meet specific individual goals such as weight gain or weight loss. Moreover, the energy value of the nutritional composition corresponds to a predetermined target calorie intake value (e.g., a 2,000 Calorie intake value). Thus, there is no need to consume any other food, but only the nutritional composition according to this disclosure.

The selection, amounts and dosages of nutritional composition ingredients can be based on individual characteristics (e.g., a gender, age, height, weight, activity level), individual goals (e.g., to remain healthy, to lose weight, to gain muscles), and nutritional rules. The nutritional rules can be based at least in part on standards created or regulated by the U.S. Food and Drug Administration (USFDA), the U.S. Department of Agriculture (USDA), the Canadian Food Inspection Agency (CFIA), the European Medicines Agency (EMEA), the Australian Therapeutic Goods Administration (TGA), and the like. In some embodiments, the nutritional rules can be also based on biophysical parameters (e.g., blood pressure, heart rate, calories burned, distances traveled, etc.). Moreover, the selection, amounts and dosages of nutritional composition ingredients depend on a predetermined target calorie intake value, which can be preselected by an individual (e.g., the individual can select a 2,000 Calorie diet, 2,500 Calorie diet, 3,000 Calorie diet, etc.) or calculated based at least on individual individual characteristics (e.g., a gender, age, height, weight, activity level) and individual goals (e.g., to remain healthy, to lose weight, to gain muscles).

The ingredients of the nutritional composition include flax seeds (or flax seeds derivatives such as hulled flax seeds, flax seed powder, flax seed kernels, milled flax seeds, or flax seed oil), hemp seeds (or hemp seeds derivatives such as hulled hemp seeds, hemp seed powder, milled hemp seeds, hemp seed kernels, or hemp seed oil), and plant flour (e.g., rice flour, soy flour, oat flour, buckwheat flour, corn flour, almond flour, barley flour, whey flour). It has been unexpectedly found that the combination of flax seeds, hemp seeds and plant flour at dosages as described herein provide various health benefits including weight loss and/or muscle gain. Moreover, this combination provides about 100% of nutrients, vitamins, minerals, fiber, fatty and amino acids to satisfy minimum dosages to intake on a daily basis as recommended by various governmental institutions such as USFDA. Moreover, these ingredients provide sources of fats, carbohydrates, and proteins in proportions scientifically found to be healthy.

In some embodiments, the flax seeds or hemp seeds can be substituted with chia seeds or chia seed derivative product (hulled chia seeds, chia seed powder, milled chia seed, chia seed kernels, or chia seed oil). Alternatively, chia seeds can be used in addition to the flax seeds and hemp seeds. The ingredients of the nutritional composition may further include sugars, salts, protein, protein isolate, and/or lecithin. In yet more embodiments, the ingredients of the nutritional composition may include flavoring agents, coloring agents, vitamins, minerals, fatty acids, amino acids, dietary fiber, banana flakes, guarana, glucuronolactone, taurine, ginseng, coffee, caffeine, tea, kola nut, cocoa, yerba mate, and/or Ginkgo biloba. The nutritional composition includes natural ingredients only, but not necessary. Moreover, the nutritional composition may include organic ingredients only, but not necessarily.

In certain embodiments, the nutritional composition includes plant flour, which can be derived from a gluten-free plant. For example, the plant flour may include rice flour, oat flour, soy flour, buckwheat flour, corn flour, their combinations or derivatives. In other embodiments, the plant flour can be derived from gluten containing plants such as wheat, barley, and/or rye.

Further, in certain embodiments, the nutritional composition includes sugars. Sugars may include one or more of the following: dextrose, glucose, fructose, sucrose, and inverted sugar. In some embodiments, sugars can be substituted with sweeteners or sugar substitutes including, but not limited to, stevia extract, tagatose, trehalose, sucralose, saccharin, neotame, aspartame, acesulfame, and so forth.

The nutritional composition may further include sesame seeds or their derivatives such as hulled sesame seeds, sesame seed powder, or sesame seed oil. In some embodiments, sesame seeds can be substituted with another ingredient having high levels of lignans (e.g., flax seeds, soybeans, apricots, etc.).

The nutritional composition may further include one or more protein ingredients such as rice protein, soy protein, whey protein, hemp protein, pea protein, casein, or any combination thereof. Thus, proteins can include diary-free proteins and/or milk-based proteins depending on particular individual characteristics and goals. In some embodiments, the nutritional composition includes a protein isolate such as whey protein isolate.

The nutritional composition may further include lecithin (phosphatidylcholine), which can be derived from soybeans, egg yolk, corn oil, and/or sunflower oil. In some embodiments, choline can be used instead of lecithin or in addition to it.

Although not required, the nutritional composition may further include one or more flavoring agents such as fruits, vegetables, nuts, chocolate, vanilla, honey, caramel, mint, peppermint, citric acid-sodium citrate, and so forth. The nutritional composition may optionally include one or more coloring agents including any of the water-soluble FD&C dyes, annatto extract, beta carotenes, turmeric, or any combination thereof. The flavoring and coloring agents are not necessarily needed for the nutritional composition, but may be added.

The nutritional composition may further include additional “energizing” ingredients including one or more of the following: guarana, glucuronolactone, taurine, ginseng, coffee, coffee extract, caffeine, tea, green tea extract, kola nut, cocoa, yerba mate, and Ginkgo biloba.

The nutritional composition, when prepared, is a ready-to-eat product, but in some embodiments can require adding one or more processing liquids. For example, the nutritional composition can be dissolved in a consumable liquid, which includes, but not limited to, water, milk, diary product (e.g., a yogurt, ice cream), and/or non-diary product (e.g., almond milk, soy milk, coconut water, juice, soda water, soft drink, lemonade, and/or energy drink).

In yet more embodiments, the nutritional composition can be processed such as subjected to thermal processing, baking, compression, grinding, and/or shaking. Accordingly, the nutritional composition in its simplest form can be provided in bulk dry mix or blend, but in other embodiments it can be provided in a liquid or semi-liquid form (e.g., as a drink, smoothie, gel), or in processed form (e.g., as a snack bar, bakery product). In either case, the nutritional composition can be provided in a container such as a wrap, bottle, polymer box, and so forth.

When the nutritional composition is prepared, it is a source of carbohydrates, fats, protein, vitamins, and minerals. The amounts of ingredients to produce the nutritional composition can be selected in order to yield predetermined proportions of carbohydrates, fats, and protein. According to embodiments of this disclosure, ingredients of the nutritional composition are selected in dosages to yield a total fat value of the nutritional composition to be at about 30% of a total calorie value of the nutritional composition; a total carbohydrate value of the nutritional composition to be in the range from about 40% to about 60% of the total calorie value of the nutritional composition; and a total protein value of the nutritional composition to be in the range from about 10% to about 30% of the total calorie value of the nutritional composition.

The total calorie value can be predetermined or calculated based on individual characteristics and goals, but generally, the total calorie value can be from 50 kcal to 5,000 kcal (or even more, if the nutritional composition is sold in bulk). The total calorie value can be also set to a predetermined value such as 1,800 kcal, 2,000 kcal, 2,200 kcal, 2,400 kcal, 2,600 kcal, 2,800 kcal, 3,000 kcal, and so forth. In yet more embodiments, the amount of nutritional composition can be provided in the form of one or more servings, and the total calorie value of each serving can be a portion of a designated daily calorie intake value determined for an individual. Overall, the energy value of each serving can be within the range of 50 kcal and 1,000 kcal. For example, if the designated daily calorie intake value for an individual is 2,000 kcal and the number of daily servings is three, then the energy value of each serving can be about 670 kcal. It should be understood that a number of servings (on a daily basis) can be two, three, four, five or more. In some embodiments, the energy value of each serving can uneven. For example, the energy value of first serving is 600 kcal, the energy value of first serving is 1,000 kcal, and the energy value of third serving is 400 kcal.

According to various embodiments of this disclosure, non-limiting formulations to make the nutritional composition, which yields the above-identified proportions of carbohydrates, fats, and proteins are set forth below in Table 1:

TABLE 1

| Ingredient | Amount |
|---|---|
| Flax seeds (or their derivatives) | about 3-6 grams per 100 kcal |
| Hemp seeds (or their derivatives) | about 1-3 grams per 100 kcal |

According to various embodiments of this disclosure, the non-limiting formulations provided in Table 1 can include additional ingredients to make the nutritional composition, which yields the above-identified proportions of carbohydrates, fats, and proteins as follows:

TABLE 2

| Ingredient | Amount |
|---|---|
| Plant flour | about 2-9 grams per 100 kcal |
| Protein | about 2-5 grams per 100 kcal |
| Sugars | about 1-7 grams per 100 kcal |
| Sesame seeds (or their derivatives) | about 0.3-1 grams per 100 kcal |
| Lecithin | about 1-3 grams per 100 kcal |

The additional ingredients shown in Table 2 are not necessarily required to produce the nutritional composition. Their selection may depend on individual needs or preferences.

According to various embodiments, the nutritional composition may include one or more vitamins and minerals. The vitamins and minerals can be added to the nutritional composition, although one or more nutritional composition ingredients can already be sources of certain vitamins and minerals. In aggregate, the nutritional composition prepared based on the above formulations include sources of vitamins in amounts as set forth below in Table 3 and include sources of minerals in amounts as set forth in Table 4:

TABLE 3

| Vitamin | Amount per serving |
|---|---|
| vitamin A | about 1,000 IU to about 5,000 IU |
| vitamin B1 | about 0.5 mg to about 2 mg |
| vitamin B2 | about 0.5 mg to about 2 mg |
| vitamin B3 | about 6 mg to about 35 mg |
| vitamin B5 | about 0.5 mg to about 10 mg |
| vitamin B6 | about 0.5 mg to about 100 mg |
| vitamin B12 | about 2 μg to about 6 μg |
| biotin | about 100 μg to about 300 μg |
| vitamin C | about 20 mg to about 2,000 mg |
| vitamin D | about 130 IU to about 400 IU |
| vitamin E | about 10 IU to about 3,000 IU |
| folic acid | about 130 μg to about 1,000 μg |
| vitamin K | about 26 μg to about 80 μg |

TABLE 4

| Vitamin | Amount per serving |
|---|---|
| calcium | about 330 mg to about 2,500 mg |
| chloride | about 1,100 mg to about 3,400 mg |
| chromium | about 40 μg to about 120 μg |
| copper | about 0.7 mg to about 10 mg |
| fluoride | about 0 mg to about 10 mg |
| iodine | about 50 μg to about 1,100 μg |
| iron | about 6 mg to about 1,100 mg |
| magnesium | about 130 mg to about 400 mg |
| manganese | about 0.7 mg to about 11 mg |
| molybdenum | about 25 μg to about 2,000 μg |
| phosphorus | about 330 mg to about 4,000 mg |
| potassium | about 1,150 mg to about 3,500 mg |
| selenium | about 23 μg to about 400 μg |
| sodium | about 800 mg to about 2,300 mg |
| zinc | about 5 mg to about 40 mg |

Tables 3 and 4 above provide a non-limiting list of the vitamins and minerals, and it should be clear that additional vitamins and minerals can be added.

According to various embodiments, the nutritional composition may include one or more fatty acids. The fatty acids can be added to the nutritional composition, although one or more nutritional composition ingredients can already be sources of certain fatty acids. The fatty acids can include unsaturated fatty acids, essential fatty acids, and/or saturated fatty acids. In certain embodiments, the nutritional composition provides omega-3 fatty acids in an amount from about 0.5 to about 1.6 grams per serving and omega-6 fatty acids in an amount from about 5 to about 17 grams per serving.

According to various embodiments, the nutritional composition may include one or more amino acids. The amino acids can be added to the nutritional composition, although one or more nutritional composition ingredients can already be sources of certain amino acids. The amino acids can include charged amino acids (arginine, lysine, aspartic, glutamic acid), polar amino acids (glutamine, asparagine, histidine, serine, threonine, tyrosine, cysteine, methionine, tryptophan), and hydrophobic amino acids (alanine, isoleucine, leucine, phenylalanine, valine, proline, glycine). In certain embodiments, the nutritional composition provides histidine in amount from about 700 to about 2,100 mg per serving, isoleucine in amount from about 950 mg to about 2,850 mg per serving, leucine in amount from about 2,200 mg to about 6,600 mg per serving, lysine in amount from about 2,000 mg to about 6,000 per serving, methionine and cysteine in amount from about 950 mg to about 2,850 mg per serving, phenylalanine and tyrosine in amount from about 1,750 mg to about 5,250 mg per serving, threonine in amount from about 1,050 mg to about 3,150 mg per serving, tryptophan in amount from about 250 mg to about 750 mg per serving, valine in amount from about 1,200 mg to about 3,600 mg per serving.

According to various embodiments, the nutritional composition may include dietary fiber. The fiber can be added to the nutritional composition, although one or more nutritional composition ingredients can already be sources of fiber. For example, the plant flour (e.g., rice or oat flour) can be a source of fiber. In certain embodiments, the nutritional composition provides dietary fiber in the range from about 5 grams to about 30 grams per daily meal or serving.

The nutritional composition may also include cholesterol. The cholesterol can be specifically added to the nutritional composition, although one or more nutritional composition ingredients can already be sources of cholesterol. In certain embodiments, the nutritional composition provides cholesterol in the range from about 10 mg to about 300 grams per serving.

Below are provided several examples of preparation of a nutritional composition in accordance with the above-given formulations.

### EXAMPLE 1

In this example, the nutritional composition is prepared by dispensing and mixing the following ingredients without any additional processing:

TABLE 5

| Ingredient | Amount per 100 kcal |
|---|---|
| Organic flax seeds | 5.02 grams ± 5% |
| Hulled hemp seeds | 2.58 grams ± 5% |
| Dextrose | 6.12 grams ± 5% |
| White rice flour | 7.96 grams ± 5% |
| White hulled sesame seeds | 0.75 grams ± 5% |

The total calorie value of the nutritional composition prepared based on the ingredients and their dosages given in Table 5 is about 100 kcal. Accordingly, if a serving size is a proportion of this calorie value (e.g., a typical calorie value of one serving can be 100 kcal-1,000 kcal). This composition includes nutrients, vitamins, and minerals in amounts recommended by the USFDA to intake on a daily basis. The above formulation can include additional ingredients as it was discussed above (e.g., include additional vitamins, minerals, liquids, etc.).

### EXAMPLE 2

In this example, the nutritional composition is prepared by dispensing and mixing the following ingredients without any additional processing:

TABLE 6

| Ingredient | Amount per 100 kcal |
|---|---|
| Organic flax seeds | 4.58 grams ± 5% |
| Hulled hemp seeds | 2.29 grams ± 5% |
| Dextrose | 2.94 grams ± 5% |
| White rice flour | 6.82 grams ± 5% |
| Chocolate | 6.07 grams ± 5% |

In this formulation, the chocolate serve not only a source of a chocolate flavor but also a source of sugars, fats, vitamins, minerals, etc. The chocolate can include 40%-60% products derived from cacao. The chocolate can be provided in the form of chocolate powder, chocolate chips, chocolate shaving, etc. This composition includes nutrients, vitamins, and minerals in amounts recommended by the USFDA to intake on a daily basis.

### EXAMPLE 3

In this example, the nutritional composition is prepared by dispensing and mixing the following ingredients without any additional processing:

TABLE 7

| Ingredient | Amount per 100 kcal |
|---|---|
| Organic flax seeds | 3.13 grams ± 5% |
| Hulled hemp seeds | 1.80 grams ± 5% |
| Dextrose | 5.67 grams ± 5% |
| White rice flour | 6.12 grams ± 5% |
| White hulled sesame seeds | 0.40 grams ± 5% |
| Soy protein isolate | 1.19 grams ± 5% |
| Vanilla cake batter soy protein | 2.49 grams ± 5% |
| Soy lecithin granules | 2.34 grams ± 5% |

This example nutritional composition provides elevated levels of protein suitable for a high-protein diet, which can help build muscles and lose fat. This composition includes nutrients, vitamins, and minerals in amounts recommended by the USFDA to intake on a daily basis.

### EXAMPLE 4

In this example, the nutritional composition is prepared by dispensing and mixing the following ingredients without any additional processing:

TABLE 8

| Ingredient | Amount per 100 kcal |
|---|---|
| Organic flax seeds | 4.53 grams ± 5% |
| Hulled hemp seeds | 2.34 grams ± 5% |
| Dextrose | 2.14 grams ± 5% |
| White rice flour | 4.53 grams ± 5% |
| Chocolate | 6.17 grams ± 5% |
| Soy protein isolate | 2.88 grams ± 5% |

This nutritional composition provides elevated levels of protein suitable for a high-protein diet, which can help build muscles and lose fat. The chocolate can include 40%-60% products derived from cacao. The chocolate can be provided in the form of chocolate powder, chocolate chips, chocolate shaving, and so forth. This composition includes nutrients, vitamins, and minerals in amounts recommended by the USFDA to intake on a daily basis.

### EXAMPLE 5

In this example, the nutritional composition is prepared by dispensing and mixing the following ingredients without any additional processing:

TABLE 9

| Ingredient | Amount per 100 kcal |
|---|---|
| Organic flax seeds | 5.08 grams ± 5% |
| Hulled hemp seeds | 2.68 grams ± 5% |
| Dextrose | 3.68 grams ± 5% |
| White rice flour | 4.73 grams ± 5% |
| White hulled sesame seeds | 0.75 grams ± 5% |
| Soy protein isolate | 1.94 grams ± 5% |
| Vanilla cake butter soy protein | 3.78 grams ± 5% |

This nutritional composition provides lowered levels of carbohydrates, which can help lose weight. This nutritional composition provides about 30% of fats, 40% of carbohydrates, and 30% protein. This composition includes nutrients, vitamins, and minerals in amounts recommended by the USFDA to intake on a daily basis.

### EXAMPLE 6

In this example, the nutritional composition is prepared by dispensing and mixing the following ingredients without any additional processing:

TABLE 10

| Ingredient | Amount per 100 kcal |
|---|---|
| Organic flax seeds | 4.67 grams ± 5% |
| Hulled hemp seeds | 2.29 grams ± 5% |
| Dextrose | 1.19 grams ± 5% |
| White rice flour | 2.74 grams ± 5% |
| Chocolate | 6.07 grams ± 5% |
| Soy protein isolate | 5.72 grams ± 5% |

This nutritional composition provides lowered levels of carbohydrates, which can help lose weight. This nutritional composition provides about 30% of fats, 40% of carbohydrates, and 30% protein. The chocolate can include 40%-60% products derived from cacao. The chocolate can be provided in the form of chocolate powder, chocolate chips, chocolate shaving, and so forth. This composition includes nutrients, vitamins, and minerals in amounts recommended by the USFDA to intake on a daily basis.

The above example nutritional compositions can be dispensed. For example, it may be required to add water, diary or non-diary liquid and steer the mixture before consumption.

According to certain embodiments of this disclosure, the nutritional composition can be prepared by an apparatus for making customized nutritional mixtures. The apparatus for making customized nutritional mixtures is described in a co-pending patent application Ser. No. 14/745,674, filed on Jun. 22, 2015, and entitled “Method and Apparatus for Making Customized Nutritional Mixtures,” which is incorporated herein in its entirety for all purposes. In alternate embodiments, the nutritional composition can be manually prepared by an individual measuring all ingredients and dispensing the same in a container for further mixing.

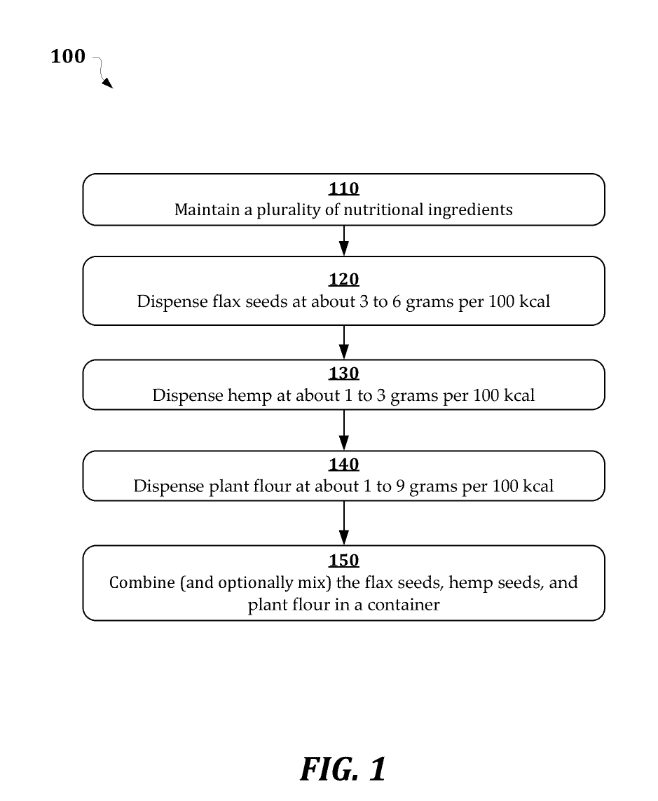

FIG. 1 shows a process flow diagram of a method 100 for making a nutritional composition, according to some embodiments. Method 100 commences at step 110 with maintaining a plurality of nutritional ingredients in one or more ingredient storage modules. The nutritional ingredients may include bulk ingredients such as dietary fiber, powders, flour, condiments, nutrients, protein, protein isolate, flavor modifiers, texturing ingredients, vitamins, minerals, and so forth. Some ingredients may include consumable liquids such as water, milk, diary products, soda, lemonade, energy drink, coffee, tea, soymilk, almond milk, and so forth.

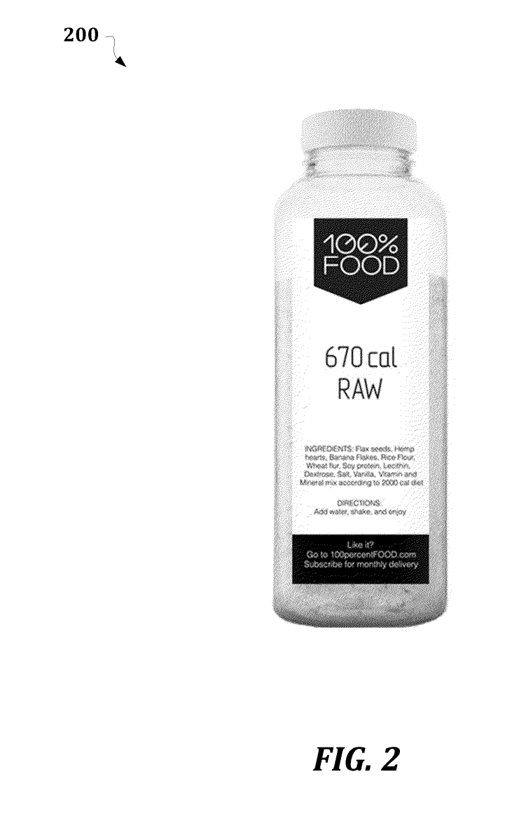

At step 120, flax seeds or their derivatives are dispensed at about 3 grams to about 6 grams per 100 kcal of the nutritional composition. The total calorie value of the nutritional composition can be predetermined (e.g., it can be 670 kcal) or individually calculated. At step 130, hemp seeds or their derivatives are dispensed at about 1 gram to about 3 grams per 100 kcal of the nutritional composition. At step 140, plant flour is dispensed at about 2 grams to about 9 grams per 100 kcal of the nutritional composition. At step 160, the flax seeds, hemp seeds, and plant flour are combined in a container and optionally steered or mixed. FIG. 2 shows an example container 200, which contains the nutritional composition prepared according to method 100. In some embodiments, container 200 may include a polymer or glass bottle.

Notably, the above-recited steps of method 100 may be implemented in an order different than described and shown in FIG. 1. Moreover, method 100 may have additional steps not shown herein, but which can be evident for those skilled in the art from the present disclosure. For example, method 100 may include additional steps such as dispensing protein, dextrose, protein isolate, lecithin, flavoring agents, liquids, or other ingredients as discussed herein. Method 100 may also have fewer steps than outlined above and shown in FIG. 1.

Thus, the nutritional composition and methods for making thereof have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A nutritional composition comprising:
flax seeds at about 3 grams to about 6 grams per 100 kcal of the nutritional composition;
hemp seeds at about 1 gram to about 3 grams per 100 kcal of the nutritional composition; and
plant flour at about 2 grams to about 9 grams per 100 kcal of the nutritional composition.

2. The nutritional composition of claim 1, wherein the plant flour includes a flour derived from a gluten-free plant.

3. The nutritional composition of claim 1, wherein the plant flour includes a rice flour.

4. The nutritional composition of claim 1, wherein the plant flour includes an oat flour.

5. The nutritional composition of claim 1, wherein the plant flour includes a soy flour.

6. The nutritional composition of claim 1, further comprising sugars at about 1 gram to about 7 grams per 100 kcal of the nutritional composition.

7. The nutritional composition of claim 6, wherein the sugars include dextrose.

8. The nutritional composition of claim 6, wherein the sugars include one or more of the following: glucose, fructose, sucrose, and inverted sugar.

9. The nutritional composition of claim 1, wherein the hemp seeds include hulled hemp seeds, milled hemp seeds, or a hemp seed derivative product.

10. The nutritional composition of claim 1, wherein the flax seeds include hulled flax seeds, milled flax seeds, or a flax seeds derivative product.

11. The nutritional composition of claim 1, further comprising sesame seeds at a range from about 0.3 grams to about 1 gram per 100 kcal of the nutritional composition.

12. The nutritional composition of claim 11, wherein the sesame seeds include white hulled sesame seeds.

13. The nutritional composition of claim 1, further comprising a protein at a range from about 2 grams to about 5 grams per 100 kcal of the nutritional composition.

14. The nutritional composition of claim 13, wherein the protein includes a rice protein, soy protein, whey protein, a hemp protein, a pea protein, casein, or a combination thereof.

15. The nutritional composition of claim 1, further comprising a protein isolate.

16. The nutritional composition of claim 1, further comprising lecithin at a range from about 1 gram to about 3 grams per 100 kcal of the nutritional composition.

17. The nutritional composition of claim 1, further comprising a flavoring agent.

18. The nutritional composition of claim 1, further comprising the following vitamins: vitamin A in amount from about 1,000 International Units (IU) to about 5,000 IU, vitamin B1 in amount from about 0.5 mg to about 2 mg, vitamin B2 in amount from about 0.5 mg to about 2 mg, vitamin B3 in amount from about 6 mg to about 35 mg, vitamin B5 in amount from about 0.5 mg to about 10 mg, vitamin B6 in amount from about 0.5 mg to about 100 mg, vitamin B12 in amount from about 2 μg to about 6 μg, biotin in amount from about 100 μg to about 300 μg, vitamin C in amount from about 20 mg to about 2,000 mg, vitamin D in amount from about 130 IU to about 400 IU, vitamin E in amount from about 10 IU to about 3,000 IU, folic acid in amount from about 130 μg to about 1,000 μg, vitamin K in amount from about 26 μg to about 80 μg.

19. The nutritional composition of claim 1, further comprising the following minerals: calcium in amount from about 330 mg to about 2,500 mg, chloride in amount from about 1,100 mg to about 3,400 mg, chromium in amount from about 40 μg to about 120 μg, copper in amount from about 0.7 mg to about 10 mg, fluoride in amount from about 0 mg to about 10 mg, iodine in amount from about 50 μg to about 1,100 μg, iron in amount from about 6 mg to about 1,100 mg, magnesium in amount from about 130 mg to about 400 mg, manganese in amount from about 0.7 mg to about 11 mg, molybdenum in amount from about 25 μg to about 2,000 μg, phosphorus in amount from about 330 mg to about 4,000 mg, potassium in amount from about 1,150 mg to about 3,500 mg, selenium in amount from about 23 μg to about 400 μg, sodium in amount from about 800 mg to about 2,300 mg, and zinc in amount from about 5 mg to about 40 mg.

20. The nutritional composition of claim 1, further comprising dietary fiber at a range from about 5 gram to about 30 grams.

21. The nutritional composition of claim 1, further comprising one or more of the following ingredients: guarana, glucuronolactone, taurine, ginseng, coffee, caffeine, tea, kola nut, cocoa, yerba mate, and Ginkgo biloba.

22. The nutritional composition of claim 1, wherein a total fat value of the nutritional composition is about 30% of total calorie value of the nutritional composition.

23. The nutritional composition of claim 1, wherein a total carbohydrate value of the nutritional composition is in the range from about 40% to about 60% of total calorie value of the nutritional composition.

24. The nutritional composition of claim 1, wherein a total protein value of the nutritional composition is in the range from about 10% to about 30% of total calorie value of the nutritional composition.

25. The nutritional composition of claim 1, wherein the nutritional composition is dissolved in a consumable liquid, wherein the consumable liquid includes water.

26. The nutritional composition of claim 1, wherein the nutritional composition is dissolved in a consumable liquid, wherein the consumable liquid includes milk or a diary product.

27. The nutritional composition of claim 1, wherein the nutritional composition is dissolved in a consumable liquid, wherein the consumable liquid includes at least one of the following non-diary products: almond milk, soy milk, coconut water, juice, soda water, soft drink, lemonade, and energy drink.

28. The nutritional composition of claim 1, wherein the nutritional composition is provided in one or more servings, wherein an energy value of each serving is not greater than 1,000 kcal.

29. A packaged food product comprising a nutritional composition, wherein the nutritional composition includes:
flax seeds or a flax seed derivative;
hemp seeds or a hemp seed derivative; and
plant flour derived from rice, oat, or soy;
wherein the nutritional composition includes a total fat value at about 30% of total calorie value of the nutritional composition, a total carbohydrate value at a range from about 40% to about 60% of total calorie value of the nutritional composition, and a total protein value at a range from about 10% to about 30% of total calorie value of the nutritional composition.

30. A method for making a nutritional composition, the method comprising:
dispensing flax seeds at about 3 grams to about 6 grams per 100 kcal of the nutritional composition;
dispensing hemp seeds at about 1 gram to about 3 grams per 100 kcal of the nutritional composition;
dispensing plant flour at about 2 grams to about 9 grams per 100 kcal of the nutritional composition, wherein the plant flour includes at least one of rice flour, oat flour, and soy flour; and
combining the flax seeds, hemp seeds, and the plant flour in a container.
